(19) United States
(12) Patent Application Publication
(10) Pub. No.: US 2015/0067774 A1
(43) Pub. Date: Mar. 5, 2015

(54) AUTOMATED METHOD FOR INCREASING AND MAINTAINING THE NUMBER OF SOCIAL MEDIA FOLLOWERS

(71) Applicant: FAHAD S H Z ALKHALED, Alsalmeya (KW)

(72) Inventor: FAHAD S H Z ALKHALED, Alsalmeya (KW)

(21) Appl. No.: 14/011,774

(22) Filed: Aug. 28, 2013

(51) Int. Cl. H04L 29/06; H04L 29/08; G06Q 50/00

(52) U.S. Cl. CPC H04L 63/08; G06Q 50/01; H04L 67/22
USPC 726/3

(57) ABSTRACT

An automated method, which acts on increasing and maintaining the number of social media followers of a particular identification (ID) on social media, is proposed. The proposed method may operate without the presence of a unique IP per user, and requires no local or central database for user information. User information is generated, encrypted, and saved on user web browser as a cookie.

### BACKGROUND OF THE INVENTION

1. Field of the Invention

Exemplary embodiments of the present invention are in the technical field of social media networking. More particularly, one exemplar embodiment of the present invention is in the technical field of user interrelations on social media. More particularly, the present invention is in the technical field of increasing and maintaining the number of followers of a user on social media.

2. Description of Related Art

In social media, reach is of great importance. It directly impacts how much entity's content and messages get shared, it increases entity's ability to get found and generate leads.

Also in social media, a user of social media is a follower who, using his/her user ID [herein after userID], subscribes to receive updates of a particular ID of another user [herein after followme(ID)], on the same particular social media web domain [herein after <www.socialmediadomain.com>].

Based on the social graph concept of social media, more followers may lead to more followers' followers. This concept is pivotal to understand the overall importance of reach. For example, on social media, possible user update (i.e. content) rebroadcast to a group or groups of other users, of an original broadcast, not only will increase one's reach, but also will give access to new, potential followers.

Also, if one can build a large base of followers, then one may expect to have few influencers among that base of followers. While those influencers may follow but stay passive, it is important to understand that these influencers have been called so for a reason, their influence may well extend one's current reach and attract further followers.

In general, social media is one of the most powerful and flexible mediums to reach individuals: having more followers is the ultimate goal.

More followers mean farther and more reach. More reach is crucially demanded by businesses, politics, and all other aspects of life. Reach is a capability that one would pay for. The massive amounts of funds being paid on promoted social actions are one of many real life examples that indicate the value of reach.

The effectiveness of any social media paid action (e.g. promoted content broadcast) heavily depends on the number of followers that are generated by that social media action relative to the number of recipients.

For the time being, there are no computerized or automated methods with a function of pushing people to follow, and maintain following, followme(ID) on social media. In fact, other than suggested practices, there are no, up to our knowledge, known automatic programmable method performing the said function.

### SUMMARY OF THE INVENTION

A new method, which acts on increasing and maintaining the number of social media followers of followme(ID) on social media web domain <www.socialmediadomain.com>, is presented. A detailed description of the proposed method follows next.

In one embodiment, when a web-based request is received, without an associated token, by a user via Internet, for accessing a particular web domain that is equipped with the presented method as a front end logic (herein after <www.example.com>), a check for the availability of user-specific cookie for that domain is performed. If the cookie is unavailable, then the user will be asked to authenticate through <www.socialmediadomain.com> using his/her userID; and user will automatically be made to follow followme(ID) on <www.socialmediadomain.com>. A call to <www.socialmediadomain.com> is then performed seeking an answer whether userID is in fact following followme(ID) on social <www.socialmediadomain.com>. If <www.socialmediadomain.com> reply to call returned a reply=Y (i.e. userID is following followme(ID)), only then, a password-less cookie will be sent to user's web browser, and access to www.example.com will be granted to the same user. Otherwise, user is asked to perform the authentication process again. If cookie is available, and if followme(ID) on social media domain is being followed by userID on <www.socialmediadomain.com>, then an access to or beyond <www.example.com> will be granted, without re-authenticating with <www.socialmediadomain.com> ever again. This is as long as cookie is available and userID is indeed following followme(ID) on <www.socialmediadomain.com>. If the call to <www.socialmediadomain.com> returned reply=N (i.e. userID is not following followme(ID) on <www.socialmediadomain>), then the cookie will be deleted on user web browser, where user is asked to perform the authentication process again. This embodiment may be applied as a front end on web domains that are made accessible to users over the internet. (e.g. media web domains, web mail domains, brand web domain, etc.).

In another embodiment, when a web-based request is received, without an associated token, via port forwarding (i.e. routed) through <www.example.com> via a Local Area Network (LAN), or internet, for accessing requested destination (where destination is different than <www.example.com>), the request, along with a unique code valid for a predefined limited time, will be saved in a buffer; and user will be redirected to <www.example.com>, where a check for the availability of <www.example.com> user-specific cookie, on user web browser, is performed. If cookie is unavailable, then the user will be asked to authenticate through <www.socialmediadomain.com> using his/her userID, where user will automatically be made to follow followme(ID) on <www.socialmediadomain.com>. A call to <www.socialmediadomain.com> is then performed seeking an answer whether the user (via userID on social media domain) is in fact following followme(ID) on <www.socialmediadomain.com>, if <www.socialmediadomain.com> reply to call returned a reply=Y (i.e. userID is following followme(ID)), only then, a password-less cookie will be sent to user's web browser, and access based on the saved request will be granted to the same user. Else user is asked to perform the authentication process again. If cookie is available, and if followme(ID) on social media domain is being followed by the user on the same social domain, then an access based on the saved request will be granted (as long as code is still valid), without re-authenticating with social media domain ever again. This is as long as cookie of <www.example.com> is available and userID is indeed following followme(ID) on <www.socialmediadomain.com>. If call to <www.socialmediadomain.com> returned reply=N (i.e. userID is not following followme(ID) on <www.socialmediadomain>), then the cookie will be deleted on user web browser, and user is asked to perform the authentication process again. This embodiment may be applied on access networks (e.g. WiFi, Cellular Data, etc.) replacing the conventional captive portal, or similar procedures.

In yet another embodiment, when a secure web request is received by <www.example.com>, with a token=userID, by a user via the Internet, for the purpose of authenticating userID on <www.example.com>, a password-less cookie will be sent to user's web browser, and user will be directed back to <www.socialmediadomain.com> with token containing userID authentication confirmation. This embodiment may be applied on web domains that are accessible to users only through <www.socialmediadomain.com>. For example, accessing a fast food chain WiFi network is only possible through accessing <www.example.com> domain of the fast food chain and receiving a cookie. The fast food chain's user cookie provisioning may be limited to be initiated only through <www.socialmediadomain.com>. Another example, accessing free media, such as movies and music, from a media provider, is only possible through accessing <www.example.com> domain of media provider and receiving a cookie. The media provider's user cookie provisioning may be limited to be initiated only through <www.socialmediadomain.com>.

The proposed method is an automated method for increasing and maintain the number of social media followers of followme(ID) on <www.socialmediadomain.com>. Furthermore, the proposed method herein requires no local or central database for user information: user information is generated, encrypted, and saved on user web browser as a cookie. Furthermore, it is important to mention that the proposed method does not require unique internet protocol address (IP) per user to function. This allows the proposed method to operate in the event of receiving requests from different users possibly having the same IP.

### BRIEF DESCRIPTION OF THE DRAWINGS

The appended claims set forth the embodiments of the present invention with particularity. The embodiments of the present invention, together with its advantages, may be best understood from the following detailed description taking into conjunction with the accompanying drawings of which:

FIG. 1 is a block diagram illustrating an embodiment of a computer;

FIG. 2 is a block diagram illustrating the embodiments of an automated method for increasing and maintaining the number of social media followers;

FIG. 3 is, from user prospective, the first exemplary virtual impression of a web page (while method execution is at block 240 of FIG. 2);

FIG. 4 is, from user prospective, the second exemplary virtual impression of a web page (while method execution is at block 240 of FIG. 2);

FIG. 5 is, from user prospective, an exemplary virtual impression of a web page (while method execution is at block 250 of FIG. 2);

FIG. 6 is a block diagram illustrating an embodiment of social media API Call/Reply with reference to follow-relation between userID and followme(ID);

FIG. 7 is, from user prospective, an exemplary virtual impression of a web page at social media domain prior to triggering block 207 of FIG. 2.

### DETAILED DESCRIPTION OF THE INVENTION

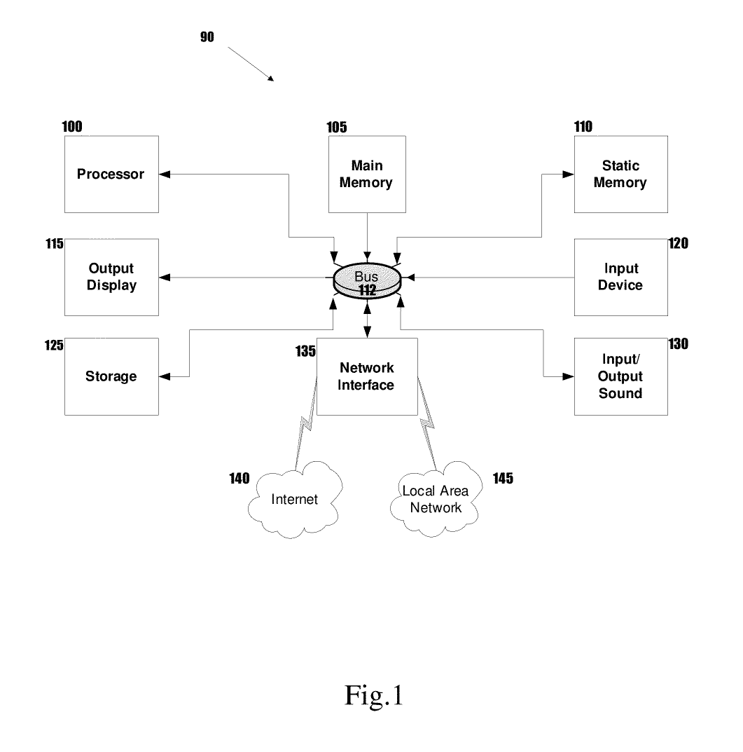

Described below, a method which acts on increasing and maintaining the number of followers relative to followme(ID) on <www.socialmediadomain.com>. Throughout the description, for the purpose of explanation, specific details are set forth in order to provide a thorough understanding of the embodiments of the present invention. It will be apparent; however, to one skilled in the art of the present invention may be practiced without some of these specific details. In other instances, well known structures and devices are shown in FIG. 1, to avoid obstructing the underlying principles of the present invention.

In the following description, various specific details are set forth such as logic implementations, types of interrelationships of objects, and logic integration choices may be set forth in order to provide more thorough understanding of various embodiments of the present invention. It will be appreciated, however, to one skilled in the art that the embodiments of the present invention may be practiced without such specific details, based on the disclosure provided. In other instances, control structures and full software instruction sequence have not been shown in detail in order not to obscure the invention. Those of ordinary skill in the art, with the included descriptions, will be able to implement appropriate functionality without undue experimentation.

Embodiments of the present invention will be described below. The embodiments may be performed by hardware components or may be embodied in machine-executable instructions, which may be used to cause a general-purpose (e.g. computer) or specific-purpose machine or logic circuits programmed with the instructions to perform the various embodiments. Alternatively, the various embodiments may be performed by a combination of hardware and software.

FIG. 1 is a block diagram illustrating an embodiment of a computer (computer) 90. As illustrated, the computer 90 includes an exemplary machine with which a set of instructions, for causing the machine to perform any one or more of the embodiments discussed herein, may be executed. The computer 90 may operate as a standalone device or may be connected (e.g. networked) to other machines or devices. In a networked deployment, the computer 90 could operate in the capacity of a server or a client machine in a client-server network environment, or as a peer machine in a peer-to-peer (or distributed) network environment. The computer 90 may be a server computer, a client computer, a personal computer (PC), a tablet PC, a notebook PC, a set-top box (STB), a personal digital assistant (PDA), a cellular telephone or smart phone, a web appliance, a programmable network router, switch or bridge, or any machine capable of executing a set of instructions (sequential or otherwise) that specify actions to be taken by that machine. Further, While only a single computer 90 is illustrated, the term “machine” or “computer” shall also be taken to include any collection of computers or machines that individually or jointly execute a set (or multiple sets) of instructions to perform any one or more of the methodologies discussed herein.

The computer 90 includes a processor 100 (e.g. central processing unit (CPU), a graphics processing unit (GPU), or both), a main memory 105 (memory), and a static memory 110, communicating with each other via a bus 112. The computer 90 further includes an output display unit 115. The computer 90 also includes an alphanumeric and cursor control input device 120 (e.g. keyboard and mouse), a data storage unit 125 (e.g. disk drive, USB storage, etc.), an input and output sound device 130 (e.g. microphone and speaker), and a network interface device 135 to connect the computer 90 with other devices or machines via a network such as internet 140, and a Local Area Network (LAN) 145.

The processor 100 may include multiple processors including one or more multi-threaded processors having multiple threads or logical processors, and may be capable of processing multiple instruction sequences concurrently using its multiple threads. The processor 100 further includes one or more microprocessors, microcontrollers, field programmable gate arrays (FPGA), application specific integrated circuits (ASIC), central processing units (CPU), programmable logic devices (PLD), and similar devices that access instructions from computer storage (e.g. main memory 105), decode and execute those instructions, by performing arithmetic and logical operations. The computer 90 may also be designed to include one or more internal caches as well.

The bus 112 is known as the host bus or the front side bus, and may be used to couple the processor 100 with other components of computer 90. The bus 112 may also be designed so that it will be coupled with a control bus, an address bus, and/or a data bus. The control bus, the address bus, and the data bus may be multidrop bidirectional buses, e.g., connected to three or more bus agents, as opposed to point-to-point bus, which may be connected only between two bus agents.

The memory 105 may include dynamic storage device, a random access memory (RAM), or other storage device coupled with the bus 112 for storing data and instructions to be executed by the processor 100. The memory 105 is also used for storing temporary variables or other intermediate data during execution of instructions by the processor 100. The static memory 110 may include a read only memory (ROM) and/or other static storage device coupled with the processor 100 via the bus 112 for storing static data and instructions for the processor 100.

The memory 105 includes a wide variety of memory devices including read-only memory (ROM), erasable programmable read-only memory (EPROM), electrically erasable programmable read-only memory (EEPROM), random access memory (RAM), non-volatile random access memory (NVRAM), cache memory, flash memory, and other memory devices. The memory 105 may also include one or more hard disks, floppy disks, ZIP disks, compact disks (e.g. CD-ROM), digital versatile/video disks (DVD), magnetic random access memory (MRAM) devices, and other computer readable media that stores instructions and/or data. The memory 105 is used to store program modules, such as routines, programs, objects, images, data structures, program data, and other program modules that perform particular tasks or implement particular abstract data types that facilitate computer 90 use.

The network interface 135 may include a modem, a network interface card, or other well known interface devices, such as those used for coupling with Ethernet, token ring, or other types of physical attachment for purpose of providing communication link to support wide area network such as internet 140, or LAN 145.

The storage unit 125 may include machine readable medium or multiple media, on which may be stored one or more sets of instructions (e.g. software) embodying any one or more of the methodologies, processes, methods, or functions described herein. The software may also reside, completely or at least partially, within the memory 105 and/or within the processor 100 during execution thereof by the computer 90, the memory 105 and the processor 100 also constituting machine-readable media. One or more sets of instructions (e.g. software) may further be transmitted or received over a network 145, or 140, via the network interface 135.

It is appreciated that a lesser or more equipped computer than the example described earlier may be desirable for certain implementations. Therefore, the configuration of the computer 90 may vary from implementation to another depending on numerous factors such as price constraints, performance requirements, technological improvements, and other circumstances.

It should be noted that, while the embodiments described herein may be performed under the control of programmed processor, such as processor 100, in alternative embodiments, the embodiments may be fully or partially implemented by any programmable or hardcoded logic, such as field programmable gate arrays (FPGAs), transistor-transistor logic (TTL), and application specific integrated circuits (ASICs). Additionally, the embodiments of the present invention may be performed by any combination of programmed general-purpose computer components and/or custom hardware components. Therefore, nothing disclosed herein should be construed as limiting the various embodiments of the present invention to a particular embodiment wherein the recited embodiments may be performed by a specific combination of hardware components.

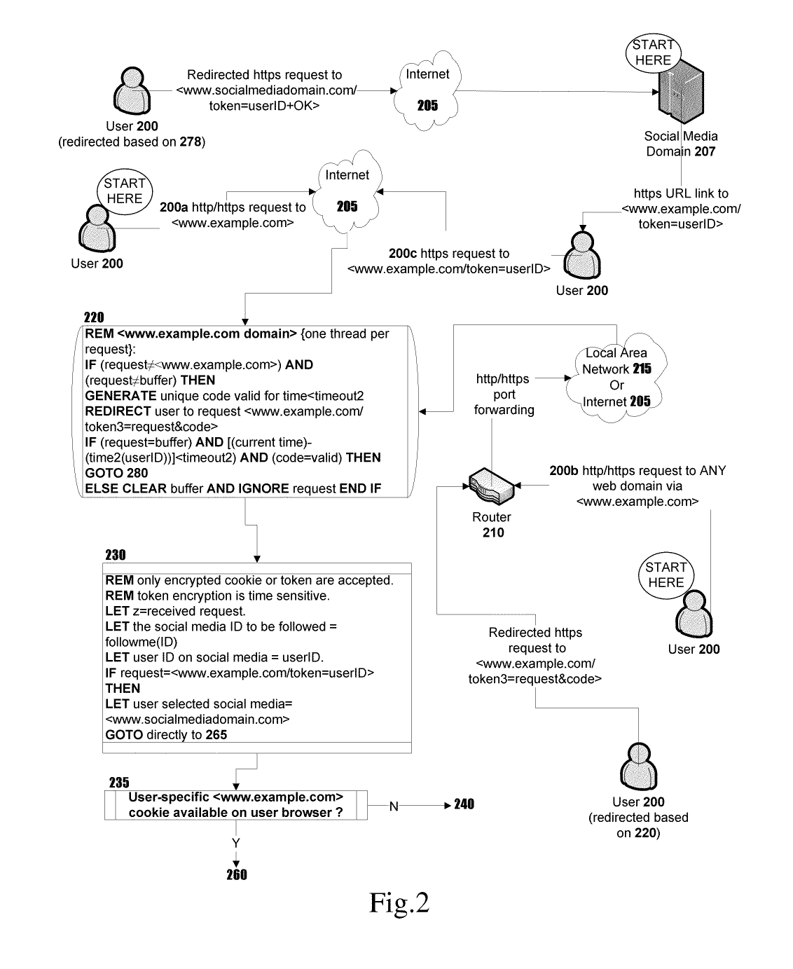

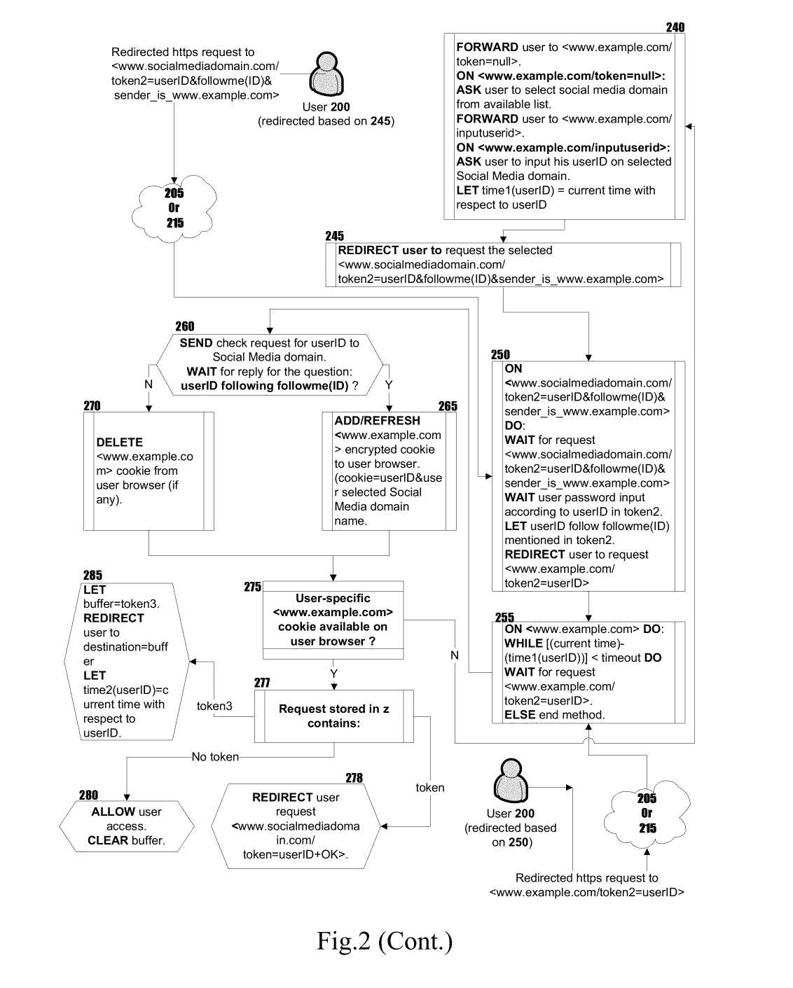

FIG. 2 is a block diagram illustrating the embodiments of an automated method for increasing and maintaining the number of social media followers. The proposed method may, as an example, be implemented as a set of machine-executable instructions loaded onto main memory 105 of a computer 90. The proposed method may be used, for instance, on a domain such as <www.example.com>, where <www.example.com> may be the proposed method as front-end logic coupled with a standard web domain, web commerce domains, web email domains, marketing web domains, a captive portal for user authentication on access network, a web proxy, media web domain, or any other form of web domain configuration and architecture. Also in FIG. 2, unless otherwise indicated, all web requests received by the proposed method are of secure http nature (https) or equivalent. More specifically, any web request, containing a token (e.g. token1, token2, token3), received by the proposed method, is assumed to be secure. Moreover, web request, with or without token, may be in any format or structure of choice, as long as the chosen format or structure does not change the objective of the exemplary web request (with or without token) format mentioned herein. A detailed description of the various embodiments of FIG. 2, follows next.

In one embodiment, a user 200 sends, through internet 205, an http or https request (200a) to <www.example.com> 220, where in processing block 230, a temporary storage z will store the entire request received from user 200 for further processing in later processing block, and a declaration for the variables “followme(ID)” and “userID” are made. Variable followme(ID) represents followme(ID) that needs to be followed by users requesting <www.example.com> for the purpose of increasing the number of followers of followme(ID).

The followme(ID) is usually, but not limited to, the social media ID of the owner of <www.example.com> relative to <www.socialmediadomain.com>. followme(ID) will have a predefined by the owner of <www.example.com>. On the other hand, userID represents the ID of user 200 on <www.socialmediadomain.com> which is the same as the social media domain of the followme(ID).

Thereafter, just when the request from user 200 reaches processing block 235, a check for the availability of <www.example.com> domain encrypted cookie on user web browser is performed (cookie encryption technique may be any technique of choice).

If cookie is unavailable, then the request by user 200 will be forwarded to <www.example.com/token=null> 240 (noting that a web forwarding process is done by the web domain within web domain local pages only, while a redirect process is requested by web domain but performed by user browser). With the said redirect in 240, the purpose of passing of a token with a null value is to flag that the proposed method will initiate user authentication process, and user 200 will be asked to input his/her preferred social media domain.

Once the user 200 selects <www.socialmediadomain.com>; he/she will be further forwarded to www.example.com/inputuserid and will be asked to enter his/her user ID (userID) relative to the selected social media domain. At this stage, a specific time stamp for userID of user 200, time1, will be recorded. Once the time1 value is recorded, request from user 200 will be redirected, to specific page within the domain of the selected social media 245 (e.g. <www.socialmediadomain.com/token2=userID&followme(ID)& sender_is_www.example.com>) for the purpose of inputting the password of the userID contained in token2 associated with the request. Token2 is a specific token containing, alongside userID, values for followme(ID), and the web domain which issued the redirect request to (sender_is_www.example.com).

Also, token2 is named as such to distinguish token2 from other tokens; as token2 specifically used to communicate with <www.socialmediadomain.com> for the only purpose of authenticating a userID by means of authenticating user input password for the userID.

In processing block 250, execution of instructions will take place only at the social media domain, where user 200, according to the redirected request <www.socialmediadomain.com/token2=userID&followme(ID)&sender_is_www.example.com> landing on the social media domain where, will be asked (i.e. user 200) to input the password of the userID he/she previously entered on www.example.com/inputuserid.

Upon successful entry of password by user 200, social media domain will internally enforce a relation where userID (available in token2) will be a follower of followme(ID) (also available in token2). Once relation enforcement complete, request will then be further redirect to the same web domain which issued the redirect request (i.e. sender_is_www.example.com). Thus, <www.socialmediadomain.com> will instruct user 200 to redirect to <www.example.com/token2=userID>. When the request is received by <www.example.com> 255, web domain <www.example.com> will only approve such a request for userID in the form of www.example.com/token2=userID as long as the time difference between current date and time, and time1, is less than the variable timeout.

Once <www.example.com/token2=userID> request is sent by user 200 to <www.example.com>, then processing block 260 will establish communication with the social media domain on the Application Programmable Interface (API) layer, better known as the API call, to social media domain (illustrated in later figure). This API call will trigger the social media domain to provide an answer, a binary answer, for the question of: is userID following followme(ID), if social media domain reply was equal to Y (i.e. userID following followme(ID)), only then, an encrypted cookie (containing userID and name of selected social media domain only, without any password) will be generated by <www.example.com> and sent to user's web browser 265.

Only then processing block 275 will check for the availability of the inserted cookie: if cookie is available then the request will proceed to block 277, else request will not be considered as of an authenticated user; thereby, rerouting request to processing block 240 again. When request reaches processing block 277, the original request issued by user 200 and stored in z, is retrieved from z. If no token is associated with the original request stored in z, then the user 200 will be allowed access 280 (i.e. any type of desired access to other web pages, or TCP ports) with respect to his/her original request as stored in z.

Furthermore, for new requests from user 200 with cookie available, if at anytime processing block 260 resulted in a reply=N, then the cookie will immediately be deleted 270 in which processing block 275 will lead user to do the authentication process starting from block 240. This embodiment may be applied in many web domains representing, for example, known commercial brands, which a user with cookie will have automatic access to their web domains, without authenticating via social media after the first time, as long as cookie is available. Cookie will stay on user browser as long as userID (of user 200) follows, and maintain following, the followme(ID) of the brand on <www.socialmediadomain.com>.

In another embodiment, a router 210 routes, via TCP port forwarding and through a Local Area Network (LAN) 215 or internet 205, any http or https request (200b) from user 200, to <www.example.com> 220. In processing block 220, if the received request is different than <www.example.com> and is also different than the value of the buffer, then a redirect request will be sent to user, via router 210, in the form of <www.example.com/token3=request&code>, where “request” represents the original request came from user via router 210, and “code” is a unique random code associated with every request contained in token3. Each code is unique by itself with limited validity. The concept of code, along with buffer, is present for the purpose of distinguishing different users; possibly sharing a common IP, thus negating the need for a unique IP per user for a successful operation of the proposed method.

The redirected request containing token3 will then reach processing block 230, a temporary storage z will store the entire request received from user 200 for further processing in later processing block, and a declaration for the variables followme(ID) and userID are made. Variable followme(ID) represents the social media ID that needs to be followed by users requesting <www.example.com> for the purpose of increasing the number of followers of followme(ID).

The followme(ID) is usually, but not limited to, the social media ID of the owner of <www.example.com> on social media domain. <followme(ID)> will have a predefined string by the owner of <www.example.com>. On the other hand, userID represents the ID of the routed user on <www.socialmediadomain.com> which is the same as the social media domain of the <followme(ID)>.

Thereafter, just when the request from user, via router 210, reaches processing block 235, a check for the availability of <www.example.com> domain encrypted cookie on user web browser is performed. Cookie encryption technique may be any encryption technique.

If cookie is unavailable, then user 200, via router 210, will be forwarded to <www.example.com/token=null> 240. The purpose of passing of a token with a null value is to flag that the proposed method will initiate user authentication process, and user 200, coming through router 210, will be asked to input his/her preferred social media domain.

Once the user selects <www.socialmediadomain.com>; he/she will be further forwarded to <www.example.com/inputuserid> and will be asked to enter his/her user ID (userID) relative to the selected social media domain. At this stage, a specific date and time stamp for userID, time1, will be recorded. Once the time1 value is recorded, request from user, via router 210 will be redirected, to specific page within the domain of the selected social media 245 (e.g. <www.socialmediadomain.com/token2=userID&followme(ID)&sender_is_www.example.com>) for the purpose of inputting the password of the userID contained in token2 associated with the request. Token2 is a specific token containing, alongside userID, values for followme(ID), and the web domain which issued the redirect request to (sender_is_www.example.com).

Also, token2 is named as such to distinguish token2 from other tokens; as token2 is specifically used to communicate with <www.socialmediadomain.com> for the sole purpose of authenticating a userID by means of authenticating user input password for the userID.

In processing block 250, execution of instructions will take place only at the social media domain, where routed user, according to the redirected request <www.socialmediadomain.com/token2=userID&followme(ID)&sender_is_www.example.com> landing on the social media domain where, routed user, will be asked to input the password of the userID he/she previously entered on <www.example.com/inputuserid>.

Upon successful entry of password by user 200, <www.socialmediadomain.com> will enforce a relation: userID (available in token2) will be a follower of followme(ID) (also available in token2). Once the relation enforcement gets completed, the request will then be further redirected to the same web domain that issued the redirect request (i.e. sender_is_www.example.com). Thus, <www.socialmediadomain.com> will instruct routed user to redirect to <www.example.com/token2=userID>.

When the <www.example.com/token2=userID> request is received by <www.example.com> 255, web domain <www.example.com> will only approve such a request for userID in the form of <www.example.com/token2=userID> as long as the time difference between current date and time, and time1, is less than the variable timeout.

Once <www.example.com/token2=userID> is received from user 200 by <www.example.com>, processing block 260 will establish communication with the social media domain on the Application Programmable Interface (API) layer, better known as the API call, to social media domain. This API call will trigger the social media domain to provide an answer, a binary answer, for the question of: is userID following followme(ID), if social media domain reply was equal to Y (i.e. user is following the required ID), only then, an encrypted cookie (containing userID and name of selected social media domain only, without any password) will be generated by <www.example.com> and sent to user's web browser 265.

Only then processing block 275 will check for the availability of the inserted cookie: if cookie is available then the request will proceed to block 277, else request will not be considered as of an authenticated user; thereby, rerouting request to processing block 240 again.

When the request reaches processing block 277, the original request issued by user 200 and stored in z, is retrieved from z. If token3 is associated with the request stored in z, then processing block 285 will let buffer=token3, where a redirect request equals token3 will be issued to user 200, and at the same time a specific time stamp for user 200 (relative to his/her userID) of user, time2, will be recorded.

Processing block 285 will lead the user, via router 210, to be automatically redirected to what is contained in buffer. At this stage, the request will reach, once again, processing block 220, from 210, through 215. At this time in processing block 220, if the code (contained in token3) is less than timeout2, and if time difference between current time, and time2, is less than the timeout period (i.e. timeout2), then the request will be directly tunneled to processing block 280 and access will be granted while clearing buffer. The granted access may be access to web pages, access to TCP ports, or any other kind of access for the user. Else the request will be ignored and buffer will be cleared. This embodiment may be adopted in access networks, by replacing the captive portal or transparent proxy with the method proposed herein. For example, a known commercial brand, say McDonalds®, may offer free wireless internet services at their locations, each location is equipped with wireless access network (e.g. WiFi access point) that is hooked to an internet feed. The access network at each location routes all web traffic (from users on the access network), via the internet feed, to a central web domain <www.example.com> (owned by McDonalds®). McDonalds® domain <www.example.com> employs, instead of a captive portal or similar procedures, the proposed method for the purpose of authenticating a user 200, by providing him/her a <www.example.com> based cookie after the userID of user 200 becomes a follower, on <www.socialmediadomain.com>, of followme(ID) defined by the owner of <www.example.com>. User 200 with <www.example.com> cookie will then have automatic access to internet web traffic via any access network within any of McDonalds® provided locations. This is without the need for authenticating via <www.socialmediadomain> after the first time, as long as cookie is available. Cookie will stay on user browser as long as user follows, and maintains following, the ID of the brand on a specific social media domain.

In yet another embodiment, social media domain 207 makes an https URL link, http/https (200c), visible on the web browser of user 200. Once user 200 clicks on the said link, a redirect request, through internet 205, will be issued to <www.example.com> 220 where the redirect request will be in the form <www.example.com/token=userID>.

Thereafter, in processing block 230, a temporary storage z will store the entire request, including token=userID, received from user 200 (as redirected by <www.socialmediadomain.com> 207), for further processing in later processing block, and a declaration for the variables followme(ID) and userID are made. Variable followme(ID) represents the social media ID that needs to be followed by users requesting <www.example.com> for the purpose of increasing the number of followers of followme(ID).

The followme(ID) is usually, but not limited to, the social media ID of the owner of <www.example.com> on social media domain. <followme(ID)> will have a predefined string by the owner of <www.example.com>. On the other hand, userID represents the ID of the routed user on <www.socialmediadomain.com> which is the same as the social media domain of the <followme(ID)>.

At the same time at block 230, if z=<www.example.com/token=userID>, then the execution of the method will directly jump to processing block 265 (bypassing processing blocks from 235 to 260, inclusive).

At processing block 265, an encrypted cookie (containing userID and <www.socialmediadomain.com> only, without any password) will be generated by <www.example.com> and sent to user's web browser.

Only then processing block 275 will check for the availability of the inserted cookie: cookie will always be available (due to processing block 265), and the request will proceed to block 277.

When request reaches processing block 277, the original request issued by user 200 and stored in z, is retrieved from z. If token=userID is associated with the original request stored in z, then processing block 278, will redirect user 200, back to <www.socialmediadomain.com> with an indication that userID authentication is successful (e.g. redirect user to <www.socialmediadomain.com/token=userID+OK>).

Furthermore, for new requests from user 200 with cookie available, if at anytime processing block 260 is visited by the proposed method, and resulted in a reply=N, cookie will immediately be deleted 270 where processing block 275 will lead user to do the authentication process starting from block 240. This embodiment may be applied on web domains that are accessible to users only through <www.socialmediadomain.com>, where a user with cookie will have automatic access to their web domains, without authenticating via social media after the first time, as long as cookie is available. Cookie will stay on user browser as long as user follows, and maintain following, the ID of the brand (i.e. followme(ID)) on a specific social media domain. This embodiment may be applied such that, For example, accessing a fast food chain WiFi network is only possible through accessing <www.example.com> domain of the fast food chain and receiving a cookie. The fast food chain's user cookie provisioning may be limited to be initiated only through <www.socialmediadomain.com>. Another example, accessing free media, such as movies and music, from a media provider, is only possible through accessing <www.example.com> domain of media provider and receiving a cookie. The media provider's user cookie provisioning may be limited to be initiated only through <www.socialmediadomain.com>.

Moreover, the proposed method in FIG. 2 requires no local or central database for user information. User information is generated, encrypted, and saved on user web browser as a cookie. Unlike conventional authentication cookies, a cookie generated by the proposed method does not contain user password. Moreover, the proposed method may substitute front end proxies or any user authentication mechanism used on any particular web domain or a subset of a particular web domain, or any centralized or distributed access network. Also, the proposed method does not require user's unique internet protocol address (user IP) information to function. Thus, it is possible for the proposed method to function with requests coming from users sharing a common IP (e.g. users on WiFi Access Point, or cellular data base station, having one single real IP communicating (possibly over internet) with <www.example.com>).

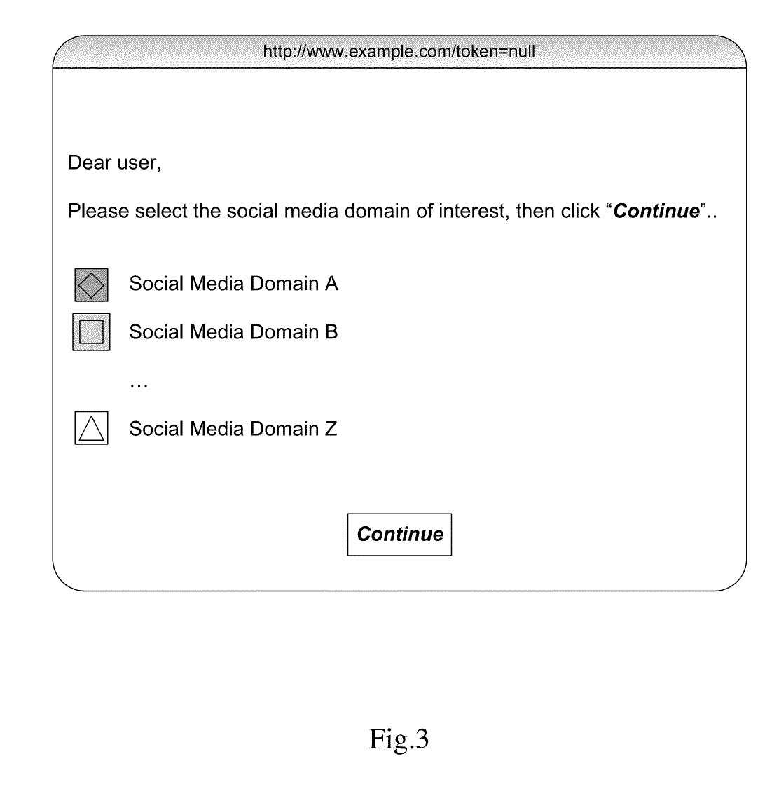

The next figure, FIG. 3, from user prospective, represents an exemplary virtual impression of web page for what the user 200, is supposed to see once his/her request is processed by <www.example.com> domain, without having an associated cookie and, at the same time, not being redirected from <www.socialmediadomain.com> 207 via (200c). From user point of view, if he/she initiates a request, or been redirected, to or through <www.example.com> without having a cookie for www.example.com, then the user 200 will see the page shown in FIG. 3, where user 200 is obliged to select one of the offered social media domains (in the form of <www.socialmediadomain.com>). User 200 must make sure that he/she have a valid userID on the social media domain <www.socialmediadomain.com> to be selected. The execution state of the proposed method will be at processing block 240 (of FIG. 2) while the virtual impression of FIG. 3 is displayed.

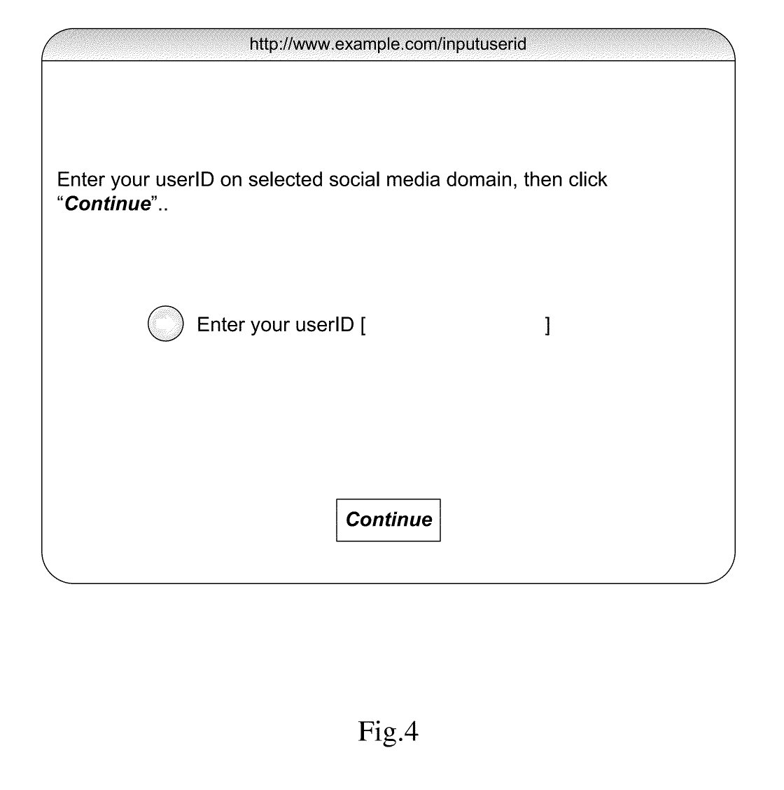

In FIG. 4 represents a continuation for the exemplary visual impression of FIG. 3, such that once social media domain <www.socialmediadomain.com> selection is made and proceeded with, the method will automatically forward the user 200 to another web page within <www.example.com>, where the user 200 will be asked to enter his/her userID relative to the selected social media domain <www.socialmediadomain.com> in the previous web page. The execution state of the proposed method will maintain being at processing block 240 (of FIG. 2) while the virtual impression of FIG. 4 is displayed.

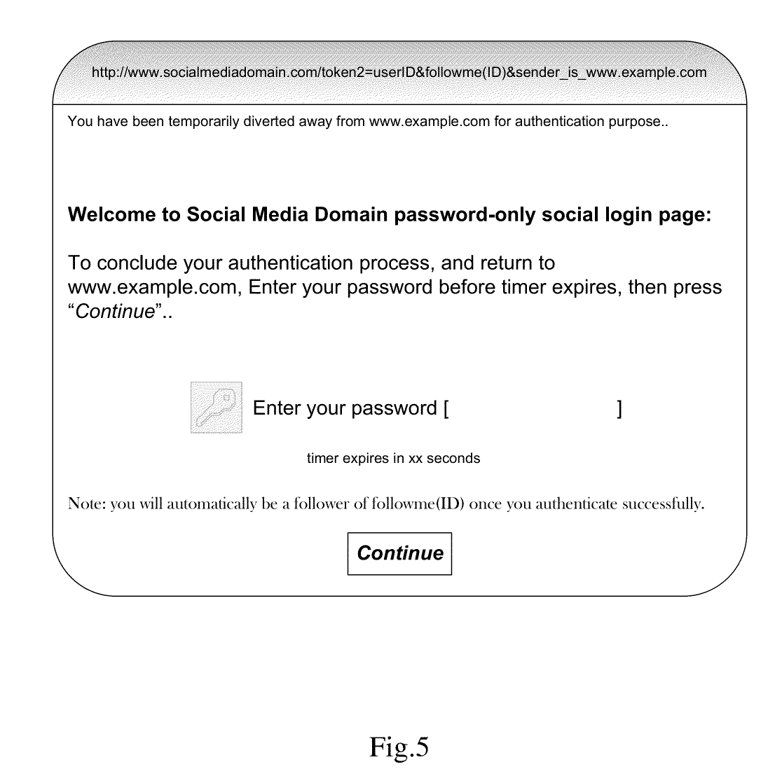

Once a user 200 enters a userID in the correct format accepted by the web page, the method will redirect the user to the selected social media domain <www.socialmediadomain.com> as in the exemplary visual impression of FIG. 5. Where FIG. 5 illustrates an exemplary virtual impression of a web page, belonging to <www.socialmediadomain.com>, where user 200 enters, within a specified time window, his/her password relative to his/her userID on this selected <www.socialmediadomain.com>. Once successful user 200 password entry within the allowed time frame, user 200 will then be redirected back to www.example.com where he/she will then be allowed access or be redirected to required destination. The execution state of the proposed method will be at processing block 250 (of FIG. 2) while the virtual impression of FIG. 5 is displayed.

If a user 200 browser does not contain cookie, then any request from user to (or routed through)<www.exmple.com> will make the user see (and satisfy) the web pages in FIG. 3, FIG. 4, and FIG. 5 before reaching what he/she requested for. Else, if user 200 browser contains cookie, any request from user to (or routed through)<www.exmple.com> will, from user 200 prospective, lead user to his/her request.

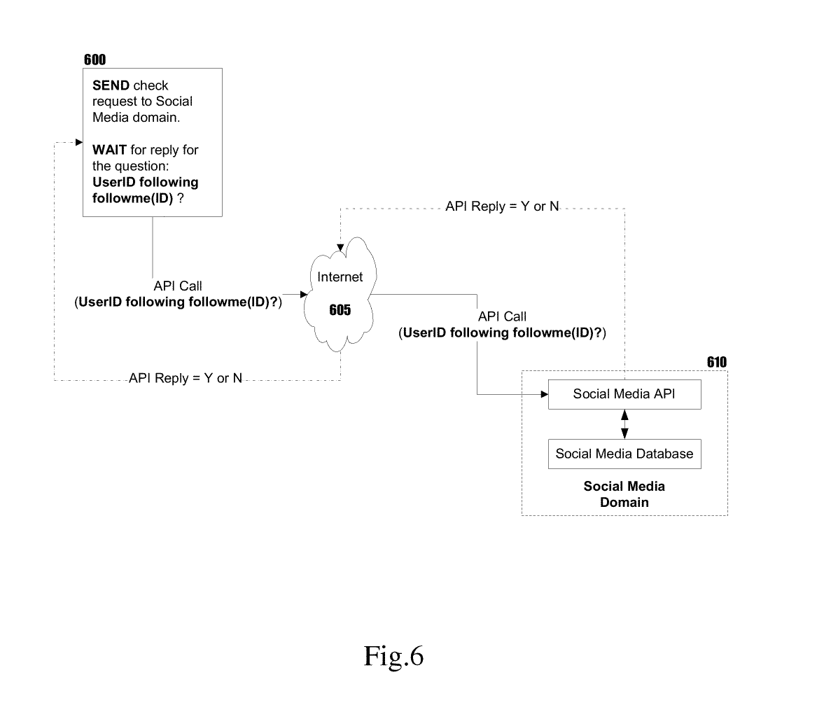

FIG. 6 is a block diagram illustrating an embodiment of social media API Call/Reply with reference to follow-relation between two social media ID's. An API, application programming interface, specifies how some software components should interact with each other (e.g. 600 and 610). In practice, most often an API is a library that includes specifications for routines, data structures, object classes, and variables.

FIG. 6 explains the mechanism of operation of processing block 260 of FIG. 2. In one embodiment, from within the proposed method, social media domain <www.socialmediadomain.com> API Call is initiated 600 and reply is expected (processing block 600 of FIG. 6 is essentially processing block 260 of FIG. 2.).

The initiated call by 600 is a request for an answer for the following logical question: (userID following followme(ID)?). The request travels over internet 605, and reaches social media domain 610 social media domain <www.socialmediadomain.com> API port. Processing block 600 of FIG. 6 is essentially processing block 260 of FIG. 2.

Social media domain <www.socialmediadomain.com> reply, with respect to the initiated call, is generated 610, using <www.socialmediadomain.com> database, in the form of a binary reply, with either Y, or N. the reply is sent by 610, via internet 605, back to proposed method through 600, where 600 will receive request and abort the WAIT status.

The binary reply value of 610 to 600, will influence the decision process of processing block 260 of FIG. 2.

It is important to note that, values for userID, and followme(ID), will be as those determined via processing blocks 230, and 235, of FIG. 2.

Also, the shape of the logical question mentioned above, or the type of response, may be in any shape or type, such that the objective of this embodiment stays as described.

The social media domain <www.socialmediadomain.com> 610 discussed herein, may be concurrently accessible through multiple simultaneous 600 or any other similar arrangement.

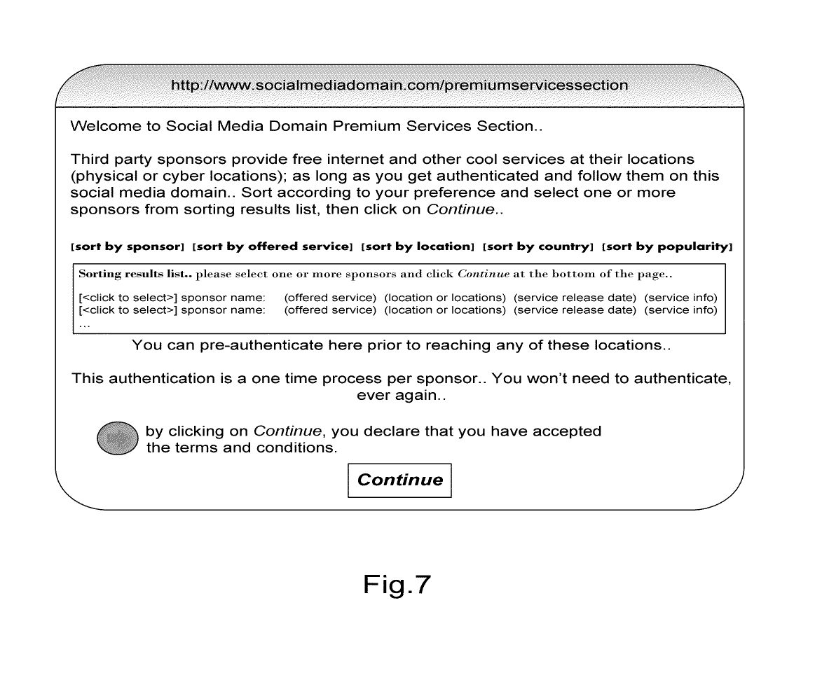

FIG. 7 is, from user prospective, an exemplary virtual impression of a web page at social media domain; prior to user clicking on the https URL link on 207 of FIG. 2 in the proposed method. In this figure, although not limited to, the following exemplary scenario is assumed: a user 200 accesses <www.socialmediadomain.com> and finds a tab for a section named, for example, “Premium Services”. The said section offers user 200 with free services sponsored by one or more domains of the form <www.example.com>. The offered free services may include free wireless access to private networks or internet, media download, streaming content, electronic vouchers, etc. Offered services are assumed to be tagged with terms and conditions of use, which requires the consent of user 200. The terms and conditions will allow user 200 to understand, as one of the conditions, that he/she is about to agree to automatically be made to follow followme(ID) using user's userID on <www.socialmediadomain.com>.

Within the exemplary visual impression in FIG. 7, user 200 will have the option to sort the list of offered free services by, for example: type/category of services, location or locations of services, by country, by date, by popularity, by one or more categories, or by any other applicable classification. The sorting process will provide the user, according to his/her sorting choice, the required information regarding the offered services and their sponsors.

User 200, for example, may choose a sorting whereby all offered services for free internet access within a specific country, say USA, are displayed. For example, the displayed sorted offered services for country=USA, may be, two sponsors: McDonalds®, and Virgin® Trains. The displayed results may include a map with the locations of each of the sponsors whereby free internet is available, plus other related information useful for the user 200.

User 200 may then choose to tick on both of the offered services by the two sponsors, accepts the terms and conditions, and then clicks on the “Continue” button.

Once user 200 clicks on the “Continue” button of FIG. 7, block 207 (of FIG. 2) is triggered, and <www.socialmediadomain.com> redirects user 200 to the <www.example.com> domain of McDonalds® (say <www.mcdonaldsdomain.com>, equipped with the proposed method), in which user 200 browser will be injected with a cookie, then redirected (i.e. the user 200) back to <www.socialmediadomain.com> by <www.mcdonaldsdomain.com>. The social media domain <www.socialmediadomain.com> will then redirects user 200 to the <www.example.com> domain of Virgin® Trains (say <www.virgintrainsdomain.com>, equipped with the proposed method), in which user 200 browser will be injected with another cookie, then redirected (i.e. the user 200) back to <www.socialmediadomain.com> by <www.virgintrainsdomain.com>.

The two successive redirect events are assumed to be executed ideally such that user 200 will not feel that he/she has left <www.socialmediadomain.com> in the first place.

User 200, with two cookies of McDonalds® and Virgin® Trains, will be pre-authenticated to enjoy free wireless internet on all of the combined listed locations of the two sponsors mentioned herein (without the need for re authentication as long as the required cookie is available). On the other hand, the sponsors will have users, such as user 200, follow them on <www.socialmediadomain.com>, even before the user reaches any of their locations.

<www.mcdonaldsdomain.com> and <www.virgintrainsdomain.com> may, if required, be hosted at the premises of the social media domain <www.socialmediadomain>. Thus, a full turnkey solution can be provided by the social media domain for the sponsors. Where sponsors will only have to route their web traffic (TCP port forwarding) to <www.mcdonaldsdomain.com> or <www.virgintrainsdomain.com>, which are both hosted at the social media domain.

User 200 may also, through <www.socialmediadomain.com>, get pre-authenticated on as many sponsored free services as required, through the same one-time operation described above.

It should be appreciated that reference throughout this specification to “one embodiment” or “an embodiment” means that a particular feature, structure or characteristic described in the connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

Similarly, it should be appreciated that in the foregoing description of exemplary embodiments of the invention, various features of the invention are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description, with each claim standing on its own as a separate embodiment of the invention.

While certain exemplary embodiments have been described and shown in the accompanying drawings, it is to be understood that such embodiments are merely illustrative of and not restrictive, and that the embodiments of the present invention are not to be limited to specific constructions and arrangements shown and described, since various other modifications may occur to those ordinarily skilled in the art upon studying this disclosure.

1. An automated method for increasing and maintaining the number of social media followers comprises:
Receiving a user-initiated web-based request, with and without an associated token, via Internet, for accessing a particular web domain;
Checking the user's web browser for the availability of a user-specific cookie for that particular web domain, such that:
If cookie is unavailable, then the user will be asked to authenticate using his/her social media web domain userID, the user will then be forced to follow another ID, followme(ID), on the same social media domain web domain, then a call to social media domain web domain is made, seeking an answer to whether userID is following followme(ID) on social media domain web domain;
If social media web domain reply to the call returned a positive response, then a password-less cookie will be sent to the user's web browser, and access to and beyond the user-requested particular web domain will be granted to the same requesting user;
If social media web domain reply to the call returned a negative response, then any previously sent cookie, by the proposed method, will be deleted from user web browser, and the user is then asked to authenticate using his/her social media web domain userID;
If cookie is available, and if followme(ID) on social media web domain is being followed by userID on the same social media web domain, then an access to some, all, or beyond the user-requested particular web domain will be granted.

2. According to claim 1, the method for increasing and maintaining the number of social media followers further comprises:
Receiving a user-initiated web-based request, with and without an associated token, via a Local Area Network (LAN) or internet, for accessing any other web destination—the request will be saved and the user will be redirected to a particular web domain;
Checking the user's web browser for the availability of a user-specific cookie for that particular web domain, such that:
If cookie is unavailable, then the user will be asked to authenticate using his/her social media web domain userID, the user will then be forced to follow another ID, such as followme(ID), on the same social media web domain, then a call to social media web domain, seeking an answer to whether userID is following followme(ID) on social media web domain;
If social media web domain reply to the call returned a positive response, then a password-less cookie will be sent to user's web browser, and the user will then be redirected to initiate a web request, contained in the initially saved request, coupled with a unique time sensitive code of arbitrary format and length, to the particular web domain;
If social media web domain reply to call returned a negative response, then any previously sent cookie, by the proposed method, will be deleted from user web browser, and the user is then asked to authenticate using his/her social media web domain userID;
If cookie is available, and if followme(ID) on social media web domain is being followed by userID on the same social media web domain, then an access to some, all, or beyond the user-requested particular web domain is allowed;
Receiving a user-initiated web-based request, with an associated token, via a Local Area Network (LAN), or internet, for accessing any other web destination, such that:
If a user-initiated web request, containing a valid non-expired code and a web address, is received, then the user will be granted access to the requested web address.

3. According to claim 1, the method for increasing and maintaining the number of social media followers, further comprises:
Receiving a user-initiated secure web-based request, with an associated token containing an encrypted userID, via a Local Area Network (LAN) or Internet, for accessing a particular web domain; then checking, using an encryption certificate or key, whether the encrypted userID is generated by social media web domain; and further checking user's web browser for the availability of user-specific cookie for that particular web domain, such that:
If the encrypted userID is generated by social media web domain, and cookie is unavailable, then a password-less cookie will be sent to the user's web browser, and the user will then be redirected to social media web domain;
If the encrypted userID is generated by social media web domain, and cookie is available, then the user will be redirected to social media web domain.

4. A set of machine executable instructions for increasing and maintaining the number of social media followers comprises:
Receiving a user-initiated web-based request, with and without an associated token, via Internet, for accessing a particular web domain;
Checking the user's web browser for the availability of a user-specific cookie for that particular web domain, such that:
If cookie is unavailable, then the user will be asked to authenticate using his/her social media web domain userID, the user will then be forced to follow another ID, followme(ID), on the same social media domain web domain, then a call to social media domain web domain is made, seeking an answer to whether userID is following followme(ID) on social media domain web domain;
If social media web domain reply to the call returned a positive response, then a password-less cookie will be sent to the user's web browser, and access to and beyond the user-requested particular web domain will be granted to the same requesting user;
If social media web domain reply to the call returned a negative response, then any previously sent cookie, by the proposed method, will be deleted from user web browser, and the user is then asked to authenticate using his/her social media web domain userID;
If cookie is available, and if followme(ID) on social media web domain is being followed by userID on the same social media web domain, then an access to some, all, or beyond the user-requested particular web domain will be granted.

5. According to claim 4, the set of machine executable instructions for increasing and maintaining the number of social media followers further comprises:
Receiving a user-initiated web-based request, without an associated token, via a Local Area Network (LAN) or internet, for accessing any other web destination—the request will be saved and the user will be redirected to a particular web domain;
Checking the user's web browser for the availability of a user-specific cookie for that particular web domain, such that:
If cookie is unavailable, then the user will be asked to authenticate using his/her social media web domain userID, the user will then be forced to follow another ID, such as followme(ID), on the same social media web domain, then a call to social media web domain, seeking an answer to whether userID is following followme(ID) on social media web domain;
If social media web domain reply to the call returned a positive response, then a password-less cookie will be sent to user's web browser, and the user will then be redirected to initiate a web request, contained in the initially saved request, coupled with a unique time sensitive code of arbitrary format and length, to the particular web domain;
If social media web domain reply to call returned a negative response, then any previously sent cookie, by the proposed method, will be deleted from user web browser, and the user is then asked to authenticate using his/her social media web domain userID;
If cookie is available, and if followme(ID) on social media web domain is being followed by userID on the same social media web domain, then an access to some, all, or beyond the user-requested particular web domain is allowed;
Receiving a user-initiated web-based request, with an associated token, via a Local Area Network (LAN), or internet, for accessing any other web destination, such that:
If a user-initiated web request, containing a valid non-expired code and a web address, is received, then the user will be granted access to the requested web address.

6. According to claim 4, the set of machine executable instructions for increasing and maintaining the number of social media followers, further comprises:
Receiving a user-initiated secure web-based request, with an associated token containing an encrypted userID, via a Local Area Network (LAN) or Internet, for accessing a particular web domain; then checking, using an encryption certificate or key, whether the encrypted userID is generated by social media web domain; and further checking user's web browser for the availability of user-specific cookie for that particular web domain, such that:
If the encrypted userID is generated by social media web domain, and cookie is unavailable, then a password-less cookie will be sent to the user's web browser, and the user will then be redirected to social media web domain;
If the encrypted userID is generated by social media web domain, and cookie is available, then the user will be redirected to social media web domain.

7. According to claim 4, the set of machine executable instructions is programmed onto a computer system.

8. According to claim 4, the set of machine executable instructions is coded onto integrated circuit components.

9. According to claim 4, wherein implementation is performed as standalone web logic.

10. According to claim 4, wherein implementation is combined with web domains that are accessible to public or private users.

11. According to claim 4, wherein implementation is performed on wired and wireless access networks.

12. According to claim 4, wherein implementation is performed on web domains that are accessible by users only after users authenticate on social media web domain.

13. According to claim 4, the method requires no local or central database for users' information, and users' information is generated, encrypted, and saved on user web browser as a cookie.

14. According to claim 4, wherein implementation does not require the presence of a unique Internet Protocol (IP) address for every requesting user.

15. According to claim 4, wherein implementation is performed inside a social media web domain.

16. According to all claims, wherein implementation is performed outside a social media web domain.
